(19) United States
(12) Patent Application Publication
(10) Pub. No.: US 2017/0104733 A1
(43) Pub. Date: Apr. 13, 2017

(54) DEVICE, SYSTEM AND METHOD FOR LOW SPEED COMMUNICATION OF SENSOR INFORMATION

(71) Applicant: Intel Corporation, Santa Clara, CA (US)

(72) Inventor: Haran Thanigasalam, San Jose, CA (US)

(21) Appl. No.: 15/085,954

(22) Filed: Mar. 30, 2016

Related U.S. Application Data
(60) Provisional application No. 62/239,730, filed on Oct. 9, 2015.

(51) Int. Cl. H04L 29/06; H04W 12/02; G06F 13/24; G06F 13/16; G06F 13/42

(52) U.S. Cl. CPC H04L 63/0492; G06F 13/1673; G06F 13/4282; H04L 63/0807; G06F 13/24; H04W 12/02

(57) ABSTRACT

Techniques and mechanisms to exchange sensor information between devices. In one embodiment, sensor data and corresponding metadata are stored, respectively, to a first buffer and a second buffer of a first device that is coupled to a host device via a hardware interface of the first device and serial bus. The sensor data and metadata are communicated to the host using a protocol that is compatible with a bidirectional, serial command interface standard. Communication of sensor information between the devices is according to a priority of the second buffer over the first buffer. In another embodiment, the metadata includes a token indicating to the host device a risk of sensor data being overwritten at the first buffer or a risk of the first buffer being starved of sensor data.

### CROSS-REFERENCE TO RELATED APPLICATIONS

This application claims the benefit of U.S. Provisional Application No. 62/239,730, filed on Oct. 9, 2015, the entire contents of which are hereby incorporated by reference herein.

### BACKGROUND

1. Technical Field

Embodiments described herein relate generally to sensor devices and more particularly, but not exclusively, to the communication of sensor information during a low-power system state.

2. Background Art

Successive generations of sensor devices are trending toward smaller, lighter, cheaper and higher performance solutions. Due to these improvements, applications for the use of such sensor devices continue to grow in number and variety. Biometric sensors and image sensors are just two types of devices that are increasingly incorporated into on-body solutions and other internet-of-things use cases. Future expansion of sensor device applications will likely rely upon incremental improvements in resource utilization by sensor devices and/or hardware that is to operate with such sensor devices.

### BRIEF DESCRIPTION OF THE DRAWINGS

The various embodiments of the present invention are illustrated by way of example, and not by way of limitation, in the figures of the accompanying drawings and in which:

FIG. 1 is a high-level functional block diagram illustrating elements of a system for exchanging sensor information according to an embodiment.

FIG. 2 is a flow illustrating elements of a method for communicating sensor information according to an embodiment.

FIG. 3 is a high-level functional block diagram illustrating elements of a system to exchanging sensor information according to an embodiment.

FIG. 4 is data diagram illustrating a format of a packet header exchanged according to an embodiment.

FIG. 5 is data diagram illustrating a format of a frame of image information exchanged according to an embodiment.

FIG. 6 is a block diagram illustrating elements of a computing system for communicating sensor information according to an embodiment.

FIG. 7 is a block diagram illustrating elements of a mobile device for communicating sensor information according to an embodiment.

### DETAILED DESCRIPTION

Embodiments discussed herein variously include techniques and/or mechanisms for communication of sensor information. Such communication may take place during a relatively low power system state—e.g., as compared to an alternative system state during which sensor information is exchanged at a higher rate (and, for example, via a different path). For brevity, such communications are referred to herein as “low speed sensor communication” or “LSSC”. Support for such communication may enable a functionality (referred to colloquially as “always-on” or “AON”) wherein sensor data is received and processed during system sleep and/or other low power states.

As used herein, “I²C/I3C” refers to compatibility with any of various I²C standards or any of various I3C standards. One example of an I²C standard is that of the I²C-bus specification Rev. 6 (4 Apr. 2014) from NXP Semiconductors, Eindhoven, Netherlands. One example of an I3C standard is that of the I3C specification ratified in September 2015 by the MIPI Alliance. “I²C/I3C” is variously used herein, for example, to indicate hardware (e.g., including a bus, interface, protocol logic and/or the like), the structure, logic and/or operation of which complies with or is otherwise compatible with a standard—such as that of an I²C specification or an I3C specification—for a bidirectional, serial control interface.

As used herein, “C/D-PHY” refers to compatibility of physical layer (PHY) hardware with a standard such as that of the D-PHY v1.2 specification of the MIPI Alliance, that of the C-PHY specification released Sep. 17, 2014 by the MIPI Alliance or any of a variety of other such specifications. “C/D-PHY” is variously used herein, for example, to indicate hardware which complies with or is otherwise compatible with a standard—such as that of a D-PHY specification or an C-PHY specification—for unidirectional, high data rate communication of payload data (e.g., including sensor data).

For brevity, “traditional image sensor” (or “TIS”) is used herein to refer to sensor devices that provide sensor data according to conventional techniques—e.g., via a C-PHY connection or a D-PHY connection (C/D-PHY) at relatively high speeds that require relatively high power state operation by a host device. By contrast, “low speed sensor” or “LSS” refers herein to any of a variety of sensor devices that support relatively low speed (low data rate) communication via an I²C, I3C or other such bus—e.g., during relatively low power states. Low speed sensors (LSSs) may include, for example, ambient light sensors, near field infrared sensors, acoustic/ultrasound sensors, presence sensors, gyroscopes, accelerometers, or a low-resolution version (e.g., QVGA) of a TIS. Although a TIS may require performance capabilities of C/D-PHY for transferring pixel content, a LSS according to an embodiment may utilize power-efficient I²C/I3C based solutions for transferring content in the range of Kbps to Mbps. A sensor device may transition, in some embodiments, between a mode for operation as a TIS and another more for operation as an LSS—e.g., where the sensor device is coupled to a host device both via a I²C/I3C bus and via a C/D-PHY interconnect. Embodiments discussed herein may include adaptations to conventional protocol techniques and mechanisms. Some embodiments may further comprises changes to software, driver, platform controller hub and or other logic to further facilitate LSSC.

“CSI-2” refers herein to compatibility with a camera serial interface standard such as that of the CSI-2 v1.0 specification of 2005 from the MIPI Alliance, CSI-2 v1.3 or any of a variety of other such specifications. A CSI-2 interface has a unidirectional high performance PHY to transfer pixel content from an image sensor to an application processor (or other host logic). The unidirectional high data bandwidth (throughput) bus may be based on a C-PHY standard or a D-PHY standard, such as one of variously specifications developed by the MIPI Alliance. In addition, the CSI-2 interface contains a bidirectional command channel called a camera command interface (CCI) that is used to configure a sensor and also to pass, for example, 3A (auto exposure, auto white balance, and auto focus) information on an as-needed basis. This bidirectional channel may be compatible with an I²C standard, or an I3C standard, for example. Certain features of various embodiments are described herein with reference to LSSC that is compatible with an I²C/I3C interface, using a protocol that is compatible in one or more respects with CSI-2. However, such description may be extended to apply to any of a variety of other additional or alternative standards/specifications.

CCI, which falls under CSI-2, provides a protocol for read-write access to registers of an imaging device. CCI is designed to be implemented, for example, with I²C or I3C interface hardware. CCI, which supports 400 kilohertz and 7-bit addressing, is a two-wire bidirectional, half-duplex, serial interface for controlling an image sensor. In addition to providing bidirectional CCI register access, CSI-2 v2.0 may be adapted according to an embodiment to optionally facilitate an exchange of payload sensor data and other sensor information using I²C/I3C-based communication mechanisms.

Embodiments facilitate exchanging sensor (e.g., pixel) data or other sensor information—e.g., rather than via C/D-PHY—via a bidirectional serial bus coupled, for example, to an I²C/I3C based interface. A bidirectional serial bus may be coupled between a sensor device and a host device, the bidirectional serial bus compatible with an interface standard (such as CCI) for exchanging command information. However, such a bus may be adapted, according to an embodiment to send payload sensor data (e.g., pixel data) and other sensor information (e.g., including corresponding metadata, sensor state information and/or the like) from the sensor devices to the host. The bidirectional bus may be I²C and/or I3C compatible and it may be used by interface logic to configure, for example, one or more registers in the sensor device. Certain embodiments variously allow for LSSC with sensor devices that do not include C/D-PHY transmitters—e.g., MEMs sensors—or with sensors that have C/D-PHY transmitters turned off or otherwise disabled. A LSS according to an embodiment may omit any C/D-PHY transmitter, for example. A LSS may operate as a conduit using I²C (or potentially I3C, which is a next version of I²C). Although certain embodiments are not limited in this regard, an LSSC-capable image (or other) sensor device may have a C/D-PHY transmitter, where a host device coupled thereto includes a C/D-PHY receiver.

A LSS that uses an I²C/I3C interface may (for example) support data rates in the range of kilobits per second to a few megabits per second. By contrast, D-PHY is typically between 80 megabits per second up to gigabits per second—e.g., 20 gigabits and even 30 gigabits per second. So C/D-PHY are substantially more performance oriented and complex compared to I²C. LSSC may provide ultra-low power conduit for Always On Imaging (AOI), gesture, analytics and/or other applications. While content from a TIS is typically transferred to an application processor (or other host device) using “push model” mechanisms such as those of C/D-PHY, content from a low speed sensor (LSS) may be transferred, according to an embodiment, using “pull model” mechanisms such as an I²C-based interrupt or an I3C-based In-Band Interrupt (IBI). A host may use such pull model mechanisms to fetch header and payload content from a LSS. Fetching LSSC content from a LSS may be interleaved with bidirectional CCI register accesses, for example.

Certain embodiments provide for a prioritization of some sensor information over payload sensor data, at least with respect to communication of the sensor information and the payload sensor data over a bidirectional serial interface. As used herein, “payload sensor data” refers to information, generated by a sensing-capable device, which describes a sensed environmental state such as a temperature, pressure, vibration, light exposure or the like. In the example embodiment of an image sensor, payload sensor data may include JPEG (or other) compressed image data or raw image data having, for example, a 12-bit pixel data format. Such payload sensor data may be distinguished from other sensor information which, for example, describes a characteristic of payload data and/or internal operation of the sensing-capable device.

To facilitate prioritized communication via a bidirectional serial interface, some embodiments variously provide at a sensing-capable device both a first buffer to store only sensor information other than any payload sensor data and a second buffer to store at least some payload sensor data. The first buffer and second buffer may both be circular buffers, for example. As compared to the second buffer, the first buffer may have a relatively small buffering capacity and a relatively high priority. This priority may be enforced or otherwise determined at the sensing-capable device and/or at a host device coupled via a bidirectional serial interface to the sensing-capable device.

Sensor information stored to the first buffer may include metadata that is determined based on payload sensor data, although some embodiments are not limited in this regard. For example, the first buffer may store error checking and correction (ECC) information used to identify and correct single bit (or other) errors of payload sensor data. Alternatively or in addition, metadata stored to the first buffer may identify or otherwise indicate an amount of sensor data that is buffered at the second buffer—e.g., where such metadata indicates whether an amount of buffered sensor data is above or below some threshold amount. In some embodiments, the first buffer stores information to configure or otherwise identify a Virtual Channel (VC) used by a sensor device—e.g., where the VC is a particular one of many VCs that has been configured by a host, or is to be so configured, for encrypted communication. In some embodiments, the first buffer is to store sensor information specifying or otherwise indicating a temperature, power level and/or other operational state of one or more sensors. Such operational state information may communicate to a host device whether the sensing-capable device is at or approaching a fatal system failure condition. Any of various additional or alternative types of sensor information may be stored at the first buffer, in different embodiments.

The second buffer may not be limited to storing payload sensor data. For example, the second buffer may be coupled to further store any of various types of user-defined and/or manufacturer-defined information such as image recognition metadata identifying a feature represented by an image. Such image recognition metadata may identify areas of an image as representing facial features, street signs and/or the like.

The technologies described herein may be implemented in one or more electronic devices. Non-limiting examples of electronic devices that may utilize the technologies described herein include any of various types of mobile devices and/or stationary devices, such as cameras, cell phones, computer terminals, desktop computers, electronic readers, facsimile machines, kiosks, netbook computers, notebook computers, interne devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, wearable electronics, combinations thereof, and the like. Such devices may be portable or stationary. In some embodiments the technologies described herein may be employed in a desktop computer, laptop computer, smart phone, tablet computer, netbook computer, notebook computer, personal digital assistant, server, combinations thereof, and the like. More generally, the technologies described herein may be employed in any of various electronic devices configured to exchange sensor information via a bus that conforms to requirements of an interface standard.

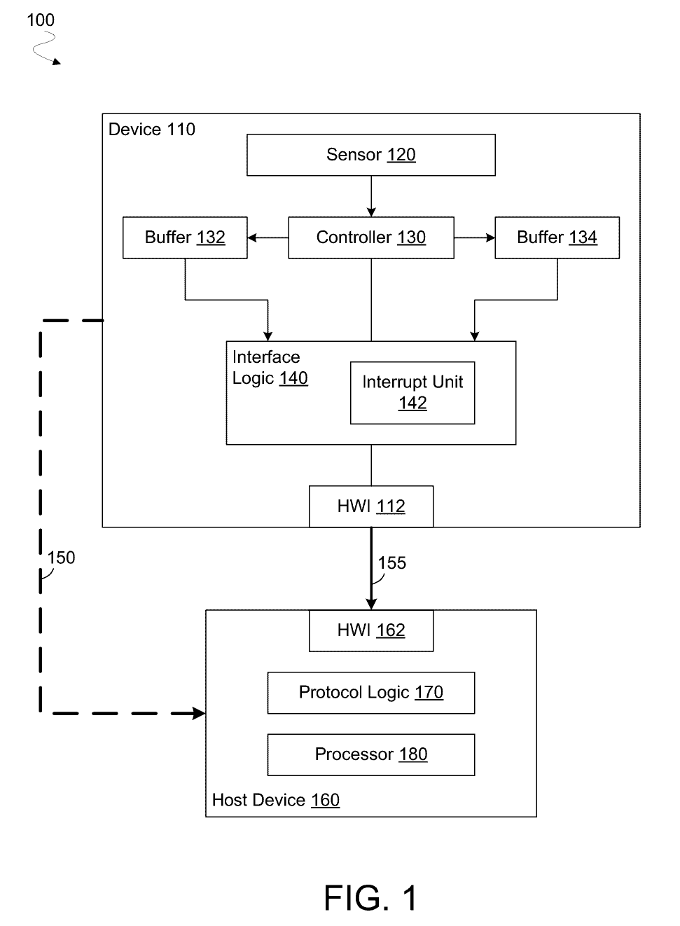

FIG. 1 illustrates elements of a system 100 to communicate sensor information according to an embodiment. System 100 may include, or function as a component of, any of a variety of electronic platforms including, but not limited to, that of a mobile device (e.g., a smart phone, tablet, palmtop, etc.), desktop computer, laptop computer, server processing-capable appliance and/or the like. In the example embodiment shown, system 100 comprises a device 110 and a host device 160 coupled to each other via respective hardware interfaces HWI 112, HWI 162, as well as via an interconnect 155. Devices 110, 160 may function as source and sink, respectively, of sensor information exchanged using interconnect 155. Some embodiments are provided entirely by only one of devices 110, 160. Other embodiments are provided by system 100. Still other embodiments are provided by a method to operate one or both of devices 110, 160 and/or by a non-transitory computer readable media including instructions that, when executed by one or more processors, cause performance of such a method with the one or more processors.

Device 110 may include one or more sensors—such as the illustrative sensor 120—to generate data representing an image, light level, pressure, motion and/or other sensed condition. A processor 180 of host device 160 may comprise a central processing unit (CPU), application processor (AP) or other sink (consumer) of sensor data generated with sensor 120.

In an embodiment, communication between device 110 and host device 160 may be compatible with an interface standard. For example, HWI 112, interconnect 155 and HWI 162 may comply with some or all interconnect hardware requirements of a standard for the communication of command and/or configuration messages. Such an interface specification may define, for example, a bidirectional, serial interface to communicate commands for configuring a camera. In one illustrative embodiment, HWI 112 and HWI 162 are compatible with an I²C/I3C specification.

Interface logic 140 of device 110 and protocol logic 170 of host device 160 may support communication according to an I²C/I3C-based protocol such as CCI (and/or an extended or otherwise modified version thereof). Some or all such logic may include circuitry, executing software, firmware or the like. Although some embodiments are not limited in this regard, devices 110, 160 may be further coupled to one another via an interconnect 155 that, for example, facilitates unidirectional communication from device 110 to host device 160. Interconnect 155 may facilitate communication according to a C/D-PHY standard, for example.

In an embodiment, LSSC is performed with hardware and/or a protocol that is compatible with CSI-2 v2.0. Such communication may be agnostic of any underlying I²C/I3C physical layer, for example. Device 110 may strictly function as an I²C/I3C bus slave device, although some embodiments are not limited in this regard. Communication via interconnect 155 may include an exchange of an in-band interrupt (MI) to request a transfer of payload sensor data and/or sensor information other than any payload sensor data. For example, processor 180 may reduce interrupt subroutine (ISR) overhead by issuing one IBI per horizontal line in a frame of image data. An LSSC protocol according to one embodiment may be derived from otherwise conventional CSI-2 over C/D-PHY mechanisms—e.g., thus maintaining various benefits of CSI-2 flexibility, multiple data types, pixel packing, and frame formats. For example, reusing CSI-2 packet header (PH) and long packet (LP) formats may potentially enable reuse of existing image processing unit and/or image sensor device logic.

To facilitate an exchange of information generated by sensor 120, device 110 many further comprise buffers 132, 134. In combination with a controller 130, for example, buffers 132, 134 many provide for a relative priority of one type of sensor information over another type of sensor information—e.g., at least with respect to LSSC via HWI 112. In an illustrative scenario according to one embodiment, a configuration process to enable LSSC includes processor 180 putting device 110 into a LSSC mode—e.g., during power-up of system 100 and/or using a CCI-compatible protocol over interconnect 155. After being so configured, device 110 may accumulate sensor data (such as image pixel data) and, in some embodiments, other sensor information such as metadata corresponding to the sensor data. Buffers 132, 134 may store different respective types of sensor information. By way of illustration and not limitation, payload sensor data (i.e., data that actually describes an image, pressure, temperature or other sensed characteristic of an environment) may be stored to buffer 132 by controller 130 or, for example, directly by sensor 120.

Alternatively or in addition, sensor information other than any such payload sensor data may instead be stored to buffer 134. Such data may include metadata that corresponds to or is otherwise determined (e.g., by sensor 120 and/or controller 130) based on the payload sensor data. In one embodiment, buffer 134 is to store token information, packet header information (such as frame start identifiers, line start identifiers, etc.) and/or other metadata that, as compared to payload sensor data, is relatively higher priority—or “mission critical”—for addressing shorter-term considerations regarding the operation of system 100. For example, controller 130 may monitor the state of buffer 132 to detect of buffer overwriting and/or buffer starvation. Based on such state, controller 130 may store to buffer 134 token information that is to indicate to device 160 whether, for example, a rate of sensor data reads is to be changed. In such an embodiment, buffer 132 may be larger than buffer 134 and/or device 160 may be configured to read payload sensor data from buffer 132 at a relatively high data rate (such as a dual data rate) to prevent such data from being overwritten prior to being read. As compared to buffer 132, buffer 134 may have a relatively small total capacity and/or may be read by device 160 at a relatively slow rate.

In response to an interrupt from device 110, protocol logic 170 (or other such circuit logic of host device 160) may service the interrupt by accessing one or both of buffers 132, 134—e.g., where protocol logic 170 is configured to prioritize accessing buffer 134 over accessing buffer 132. By way of illustration and not limitation, protocol logic 170 may retrieve mission critical data from buffer 134 before determining whether to access buffer 132 in response to the interrupt. Any accessing of buffer 132 in response to the interrupt may be conditioned, for example, upon an evaluation of the sensor information retrieved from buffer 134. For example, buffer 134 may provide to host device 160 sensor information indicating that payload sensor data being written to buffer 132 is not currently relevant in one or more respects. Such a situation may occur, for example, where information from a forward looking sensor of a car is not needed while the car is moving in a reverse direction. In response, protocol logic 170 may selectively forego accessing buffer 134.

LSSC according to some embodiments may allow for I²C/I3C bus sharing. Therefore, LSSC may support error signaling by device 110. By way of illustration and not limitation, an interrupt unit 142 of device 110—e.g., the interrupt unit 142 included in, or otherwise accessible to, interface logic 140—may signal to host device 160 that it is not keeping up with real-time transfers (e.g., streaming) of pixel data and/or other sensor information. For example, interrupt unit 142 may signal, based on a state of buffers 132, 134, that an in-band (or other) interrupt is to be sent via interconnect 155 to indicate that sensor data and/or other sensor information is available to be drained from buffers 132, 134. Alternatively or in addition, interrupt unit 142 may detect an in-band (or other) interrupt from device 160—e.g., where such interrupt is to request information from one or both of buffers 132, 134. In an illustrative embodiment, interconnect 155 includes I²C signal lines, as well as an additional wire for communicating an in-band interrupt (IBI).

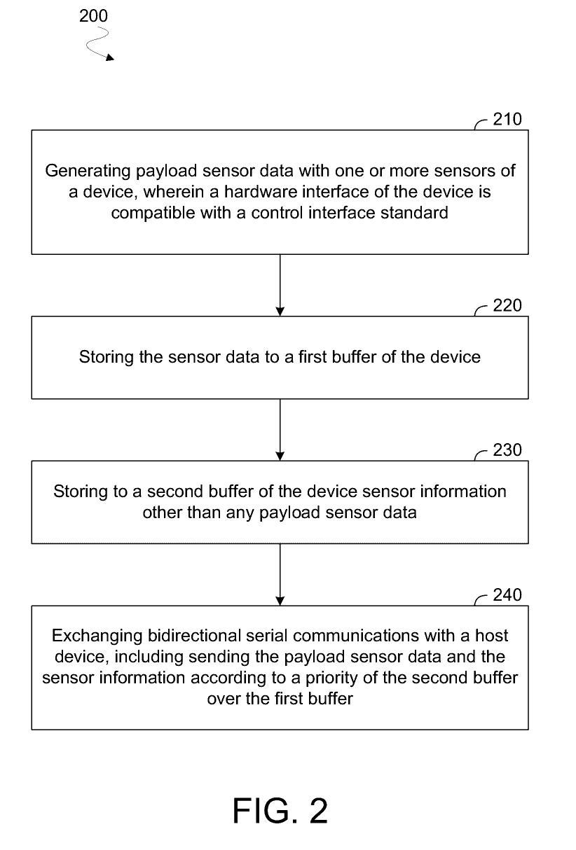

FIG. 2 illustrates elements a method 200 to communicate sensor information according to an embodiment. Method 200 may be performed by one or more components of system 100, for example. In one embodiment, operations of method 200 are performed by a sensor device having some or all of the features of device 110.

Method 200 may include, at 210, generating payload sensor data with one or more sensors of a device (such as device 110) that is coupled to a host via a hardware interface of the device and an interconnect between the device and the host. For example, the first device may include any of a variety of sensor-capable devices including, but not limited to, an image sensor array, infrared sensor, ambient light sensor, pressure sensor, inertial sensor (e.g., a gyroscope), optical image stabilization logic and/or the like. The host device may comprise an application processor (APP) or other circuit logic capable of receiving and processing sensor information from the device. The hardware interface may be compatible with a control interface standard, such as that of a CSI-2 specification, that defines a bidirectional serial interface for the exchange of command messages. In an embodiment, the hardware interface is compatible with an I²C/I3C connection specification.

Method 200 may further include, at 220, storing the payload sensor data to a first buffer of the device and, at 230, storing, to a second buffer of the device, sensor information other than any payload sensor data. The sensor information may be determined based on a state of a sensor, based on information specified by the payload sensor data or, for example, based on a characteristic of a storage of such payload sensor data at the first buffer. By way of illustration and not limitation, the sensor information stored at 230 may include a token to identify or otherwise indicate a risk of buffered sensor data being overwritten or (alternatively) depleted.

In some embodiments, method 200 further comprises, at 240, exchanging bidirectional serial communications with the host device, including sending the payload sensor data and the sensor information from the device via the hardware interface according to a priority of the second buffer over the first buffer. For example, interface logic of the device may include or otherwise have access to one or more rules which each define a respective situation where the second buffer is to be selected, in lieu of the first buffer, as a source of sensor information that is to be sent in some upcoming communication with the host. Such rules may define one or more “but for” conditions—e.g., wherein payload sensor data in the first buffer would otherwise be selected for communication to the host in the absence of any such condition. In one illustrative embodiment, such a condition may include the storage of a particular type of token (or multiple types of tokens) to the second buffer.

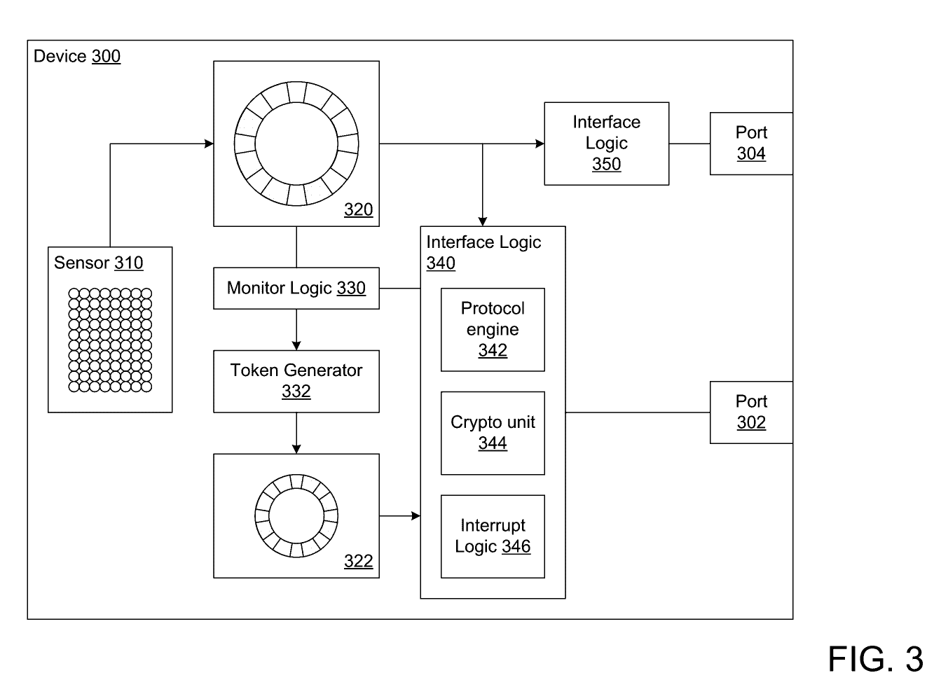

FIG. 3 illustrates elements of a device 300 to communicate sensor information according to another embodiment. Device 300 may include some or all of the features of device 110, for example. In an embodiment, device 300 provides functionality to perform some or all of method 200.

Device 300 may include a sensor 310, buffers 320, 322, interface logic 340 and port 302 having, for example, respective functionality corresponding to that of sensor 120, buffers 132, 134, interface logic 140 and HWI 112. Control logic of device 300 may include monitor logic 330 that, in an embodiment, regularly evaluates a state of buffer 320. For example, monitor logic 300 may periodically detect whether or not an amount of sensor data that has yet to be read from buffer 320 is above some predetermined maximum threshold (and/or below some predetermined minimum threshold). Based on a current state of buffer 320, monitor logic 330 may generate metadata or other sensor information to be communicated to a host device (not shown) that is coupled to device 300 via port 302. For example, monitor logic 330 may signal to a token generator 332 that a token is to be stored at buffer 322. Such a token may indicate a risk of yet-to-be-read sensor data in buffer 320 being overwritten. Alternatively, the token may indicate a risk of buffer 320 being starved of unread sensor data.

A protocol engine 342 of interface logic 340 may support a protocol for LSSC that, for example, is compatible with a bidirectional, serial interface standard such as CCI. As compared to C/D-PHY mechanisms, LSSC functionality of device 300 may require only an ultra-low power footprint—e.g., for lower resolution sensor information exchanged using I²C-compatible interface mechanisms. For example, device 300 may be a component of a mobile platform, which operates to distinguish whether the platform is in a confined area (e.g., a glovebox, a pocket etc.) or in an area that is exposed to ambient light. Even detection of gesture events may be supported with LSSC by device 300. In an illustrative scenario according to one embodiment, sensor 310 includes a 320×200 (for example) array of image sensor elements configured to capture a frame comprising 200 horizontal rows, each of which contain payload information for 320 pixels (e.g., at 8 bits per pixel, 10 bits per pixel, or the like). A frame start (FS) may be sent with the first line and a frame end (FE) sent with the 200th line. A line start (LS) is used to distinguish one horizontal line from one another. After the last line of one frame (Frame 1) is received, a first line of a next frame (Frame 2) may be indicated by another frame start FS2 and a line start LS.

Very low cost light sensor elements—that consume maybe 100th of a power of a traditional image sensor—could be arranged in an array (e.g., 8×8 or a 16×16) of sensor 310. The resolution provided by such a sensor array may be sufficient to recognize an event such as a person pointing a thumb upward or downward for basic gesture recognition. Such gesture recognition (and/or other functionality) may be provided without having to opt for traditionally made sensors, which are substantially more expensive and certainly more complex with C/D-PHY. A much simpler I²C/I3C-type bus may instead be used.

Although some embodiments are not limited in this regard, interface logic 340 may further comprise or couple to a cryptographic unit 344 that is to facilitate encryption/decryption of sensor information exchanged via port 302. Some embodiments provide a dedicated channel for enterprise (or other) applications related to biometrics and/or other such security functionality. Iris scan and retinal scan are some examples of increasingly prevalent use cases in such enterprise applications. For example, sensor 310 may operate to capture an image of a person's retina, where the image is transferred through LSSC using functionality of protocol engine 342 that is compatible with I²C/13C in one or more respects. In an embodiment, at least part of the image data is encrypted be cryptographic unit 344, in case the line is snooped (by a spoofing or otherwise malicious agent).

In an embodiment, a packet header (PH) precedes a set of sensor information (referred to as a long packet) including pixel data and/or other information such as corresponding metadata. A virtual channel (VC) field of the PH may be used to uniquely identify a format of sensor data (RAW, compressed JPEG), metadata, embedded data, etc. In order to securely transfer sensitive pixel data of retina/iris scan of an eye, some embodiments encrypt pixel data used for secure user authentication. For example, sensor data may be encrypted and transferred via one or more allocated VCs using an Advanced Encryption Standard AES-128/256 key provided from a host device to a sensor device (such as one of devices 110. 300).

Referring again to FIG. 1, processor 180 may transfer an AES key to device 110 via CCI messaging exchanged using a secure I²C/13C channel. Subsequently, processor 180 may configure device 110 to use a particular encrypted VC along with the capture format (RAW/JPEG/Metadata/etc) using the CSI-2 CCI. Device 100 may generate an encrypted long packet of payload sensor data using the configured AES key. Processor 180 may include or otherwise maintain configuration information for determining the AES key and list of any VCs that had been configured to serve as an encrypted channel. Upon receipt of an encrypted long packet, the host device may use the AES key to decrypt the sensor data therein.

Interrupt logic 346 of device 300 may operate to communicate via port 302 an IBI indicating, for example, that sensor information (e.g., including data and/or corresponding metadata) is ready to be transferred. An IBI may exploit protocol mechanisms of an existing interface standard—e.g., as opposed to having to allocate additional wires and additional circuits to implement such an interrupt mechanism. The IBI may signal host logic to read sensor data content (and/or corresponding metadata) from one or both of buffers 320, 322. In an embodiment where device 300 does not support IBI functionality, a legacy (e.g., out-of-band) interrupt mechanism may be used.

In an illustrative scenario according to one embodiment, interrupt detector 346 may provide an IBI for the host logic to drain one or more lines (e.g., a frame) of image data. Buffer 320 may accumulate sensor data that is needed for a second horizontal line of an image while the host logic is receiving via port 302 sensor data for a first horizontal line. Device 300 may subsequently issue a second IBI indicating the second data line is ready to go. Provided the host logic is able to drain data for subsequent image lines on time, LSSC communications may continue.

In some embodiments, buffers 320, 322 (e.g., including respective register banks) store different respective types of sensor information. One example of such different data types includes what may be referred to as “mission critical” content (including, for example, transport information) which—at least with respect to LSSC—is prioritized over what is referred to herein as “best-deferred” sensor information. Best-deferred sensor information may be mostly or entirely payload sensor data. By contrast, mission critical content may be much smaller, but relatively more important for providing fast and/or reliable communication to a host. Timely delivery to the host may thus be more important, as compared to best-deferred data. In some embodiments, an IBI (or other interrupt) itself includes criteria information indicating an interrupt priority specific to the communication of mission critical content. Such criteria information may specify or otherwise indicate to the host logic a particular circular buffer from which to drain (read) sensor information.

Some embodiments utilize data formats that are currently supported in the industry and/or formats that are under consideration by one or more standards bodies—e.g., including one or more formats of already known and disseminated C/D-PHY technology to support IBI, for example. An I²C-based implementation may require an additional interconnect wire to communicate an interrupt, whereas an 13C-based implementation may exploit conventional IBI mechanisms.

Although some embodiments are not limited in this regard, device 300 may further comprise another port 304 and additional interface logic 350 comprising circuitry to exchange sensor data according to a different interface standard. For example, interface logic 350 and port 304 may support communication of image data and/or other sensor information at relatively high data rates—e.g., according to C/D-PHY. Accordingly, a host device (not shown) coupled to device 300 may receive first sensor data from port 302 during a low power state of the host device. In such an embodiment, other sensor data may be provided from device 300 via port 304 during a relatively high power state of the host device. In other embodiments, device 300 omits interface logic 350 and port 304.

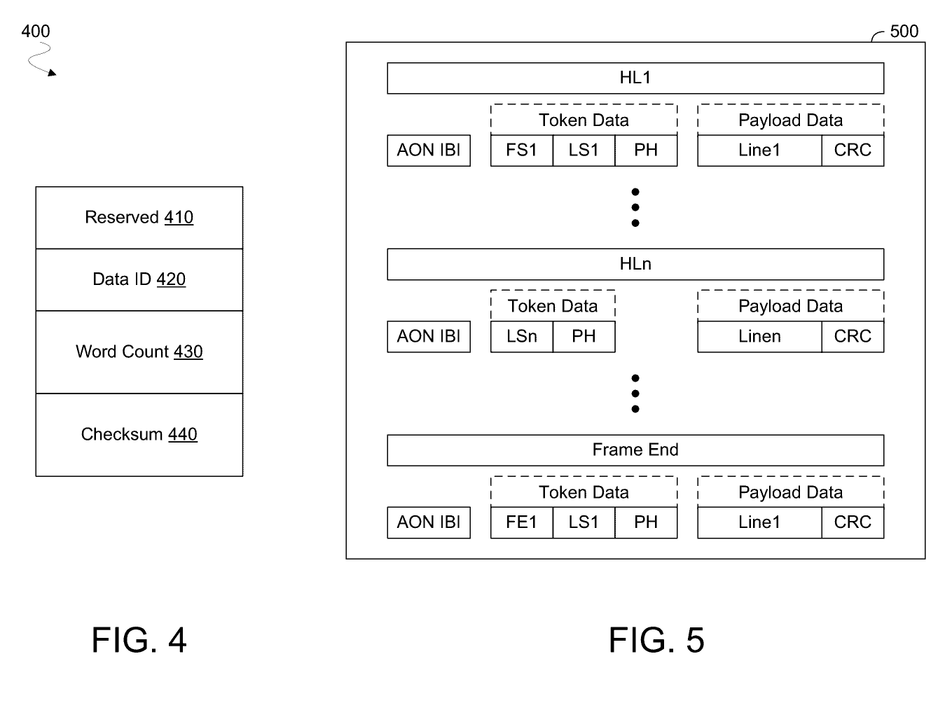

As illustrated in FIG. 4, a packet header (PH) format 400 according to one embodiments may include a reserved field 410, a data identifier (ID) field 420, a word count field 430 to indicate a size of the packet, and a checksum field 440. However, any of a variety of combinations and arrangements of the same, additional or alternative information may be included in a packet header, in various embodiments. Packet header format 400 is similar to one currently adopted and used for C/D-PHYs. Thus, some embodiments may adapt at least some existing protocol logic to support LSSC functionality.

Referring now to FIG. 5, a format 500 of a frame of image data communicated via a LSSC exchange is shown. In format 500, a frame of captured image information (e.g., including one of a sequence of frames) comprises a respective plurality of horizontal lines of pixel data. Each horizontal line may be associated with respective token (mission critical) data and respective payload (best-deferred) data. Token data may include a frame start (FS) identifier to indicate the beginning of a frame or a frame end (FE) to indicate the end of a frame. The token data may further comprise a line start (LS) identifier to indicate the beginning of a next horizontal line and/or a packet header (PH) including information about the payload data. FIG. 4 illustrates one example of a format 400 for such a packet header.

The token data may begin with a line start (LS), although this may be optional, in some embodiments, to selectively enable more efficient transfer of sensor data. An LSSC interrupt (represented as “AON IBI”) may be an I3C-based IBI mechanism. A cyclic redundancy check (CRC) field of payload data may be optional. CRC in conventional I²C is mandatory, but is optional in conventional I3C. In some embodiments, CRC may be disabled in order to save dynamic power if the bit error rate of the I²C/I3C bus is relatively low. Accordingly, a LSSC transfer sequence may have a line start that is optional (may be omitted from the token data) and/or a CRC that is optional (may be omitted from the payload data). CRC and LS may be disabled by default, for example. Such embodiments are based on a realization that host logic may be efficient enough to forego the need for LS and/or CRC indicators.

If payload (best-deferred) sensor data is debuffered slowly, one device—e.g., device 110 or host device 160—may communicate a risk of buffer overflow to the other device using an overflow error token. Such a token may be represented, for example, as a pre-defined (e.g., user-defined) data type of the packet header. In an embodiment, a packet header according to format 400 includes data ID field 420, wherein the storing of a particular data type value data ID field 420 is predefined as representing a data overflow error. Should there be an overflow, a sensor device (such as one of devices 100, 300) may indicate it to host logic by including in a packet header a corresponding identifier. For example, the data ID field 420 of the packet header may store a value indicating an overflow. In response to detecting an overflow identifier, the host logic may discontinue gathering additional sensor data, and may instead communicate with the sensor device to resolve the overflow event—e.g., to recover older data. For example, a sensor device may snoop an IBI before the host logic completes draining the payload data buffer. However, if the host logic is able to complete reading payload data buffer before the sensor device overwrites the payload data buffer, loss of sensor data may be prevented.

The data ID field 420 may additionally or alternatively identify a data formats—e.g., one of a jpeg format, a raw sensor data format, etc. The way pixels are represented by a given data format (or how the frame is represented in one of different possible data formats) may be associated with a corresponding virtual channel. Image processor logic of a host may gather payload sensor data, from one or more image sensors, that is of one given format. The data of that format type may be processed using that particular virtual channel.

In an embodiment, an image sensor may receive from a host or other trusted agent with an AES (or other) encryption key—e.g., AES-128 or AES-256—corresponding to an AES decryption key of the host logic. During a preliminary system power-up configuration process, for example, a given set of sensor data processing resources (also referred to herein as a virtual channel) may be allocated cryptographic processing resources (e.g., an encryptor and/or a decryptor). Such configuring may depend, for example, on a version of CSI-2 which the sensor device supports. For instance, if it is CSI-2 version 1.3, then the sensor device may support four (4) virtual channels. If it is CSI-2 version 2.0, the sensor device may support up to 32 virtual channels. Subsequent to virtual channel configuration, sensor data may be sent through a virtual channel selected for cryptographic processing, where the payload content therein would be encrypted. The virtual channel may be indicated, for example, by an identifier in data ID field 420 of a packet header. Data ID may be an 8-bit, 16-bit, or other field, allocated for identifying data type.

Some embodiments allocate 2-bits of a data ID field 420 to identify up to four virtual channels. For example, a virtual channel 3 may be encrypted and an image sensor used for iris scanning uses virtual channel 3. Therefore, if a malicious agent snoops the I²C/I3C bus (and/or some available C/D-PHY interconnect), it would be very challenging to fully access the encrypted content. In some embodiments, selective portions of image (or other sensor) data may be sent via an I²C/I3C bus concurrently with the rest of the image data being exchanged via a C/D-PHY connection. Certain pixels, portions of pixels, portions of encrypted sensor data or the like may be selectively chosen for communication via LSSC instead of via a concurrent C-D-PHY exchange. Malicious agents would then have to snoop both the I²C/I3C and the C/D-PHY connections to correctly recreate sensor information.

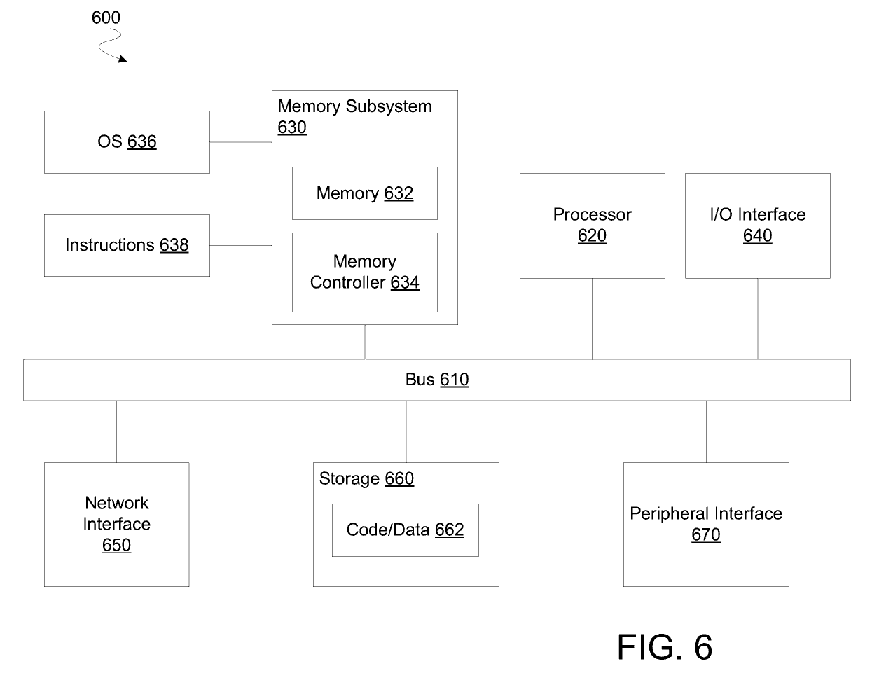

FIG. 6 is a block diagram of an embodiment of a computing system in which processing of sensor information may be implemented. System 600 represents a computing device in accordance with any embodiment described herein, and may be a laptop computer, a desktop computer, a server, a gaming or entertainment control system, a scanner, copier, printer, or other electronic device. System 600 may include processor 620, which provides processing, operation management, and execution of instructions for system 600. Processor 620 may include any type of microprocessor, central processing unit (CPU), processing core, or other processing hardware to provide processing for system 600. Processor 620 controls the overall operation of system 600, and may be or include, one or more programmable general-purpose or special-purpose microprocessors, digital signal processors (DSPs), programmable controllers, application specific integrated circuits (ASICs), programmable logic devices (PLDs), or the like, or a combination of such devices.

Memory subsystem 630 represents the main memory of system 600, and provides temporary storage for code to be executed by processor 620, or data values to be used in executing a routine. Memory subsystem 630 may include one or more memory devices such as read-only memory (ROM), flash memory, one or more varieties of random access memory (RAM), or other memory devices, or a combination of such devices. Memory subsystem 630 stores and hosts, among other things, operating system (OS) 636 to provide a software platform for execution of instructions in system 600. Additionally, other instructions 638 are stored and executed from memory subsystem 630 to provide the logic and the processing of system 600. OS 636 and instructions 638 are executed by processor 620.

Memory subsystem 630 may include memory device 632 where it stores data, instructions, programs, or other items. In one embodiment, memory subsystem includes memory controller 634, to access memory 632—e.g., on the behalf of processor 620. Processor 620 and memory subsystem 630 are coupled to bus/bus system 610. Bus 610 is an abstraction that represents any one or more separate physical buses, communication lines/interfaces, and/or point-to-point connections, connected by appropriate bridges, adapters, and/or controllers. Therefore, bus 610 may include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 610 may also correspond to interfaces in network interface 650.

System 600 may also include one or more input/output (I/O) interface(s) 640, network interface 650, one or more internal mass storage device(s) 660, and peripheral interface 670 coupled to bus 610. I/O interface 640 may include one or more interface components through which a user interacts with system 600 (e.g., video, audio, and/or alphanumeric interfacing). In one embodiment, I/O interface 640 includes a touch controller to operate a touch sensor array that is included in or coupled to I/O interface 640. The touch controller may be coupled via a D-PHY to digital processor logic that is to perform digital processing of touch sensor information that is provided by the touch controller—e.g., with techniques and/or mechanisms discussed herein. Such digital processor logic may reside, for example, in I/O interface 640 or processor 620.

Network interface 650 provides system 600 the ability to communicate with remote devices (e.g., servers, other computing devices) over one or more networks. Network interface 650 may include an Ethernet adapter, wireless interconnection components, USB (universal serial bus), or other wired or wireless standards-based or proprietary interfaces.

Storage 660 may be or include any conventional medium for storing large amounts of data in a nonvolatile manner, such as one or more magnetic, solid state, or optical based disks, or a combination. Storage 660 holds code or instructions and data 662 in a persistent state (i.e., the value is retained despite interruption of power to system 600). Storage 660 may be generically considered to be a “memory,” although memory 630 is the executing or operating memory to provide instructions to processor 620. Whereas storage 660 is nonvolatile, memory 630 may include volatile memory (i.e., the value or state of the data is indeterminate if power is interrupted to system 600).

Peripheral interface 670 may include any hardware interface not specifically mentioned above. Peripherals refer generally to devices that connect dependently to system 600. A dependent connection is one where system 600 provides the software and/or hardware platform on which operation executes, and with which a user interacts.

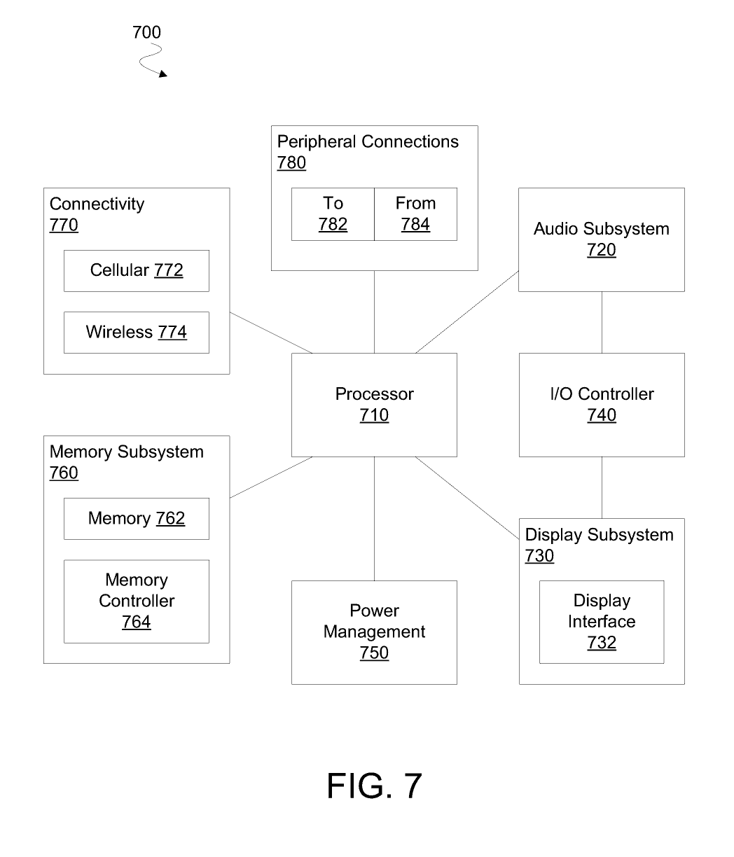

FIG. 7 is a block diagram of an embodiment of a mobile device in which processing of sensor information may be implemented. Device 700 represents a mobile computing device, such as a computing tablet, a mobile phone or smartphone, a wireless-enabled e-reader, or other mobile device. It will be understood that certain of the components are shown generally, and not all components of such a device are shown in device 700.

Device 700 may include processor 710, which performs the primary processing operations of device 700. Processor 710 may include one or more physical devices, such as microprocessors, application processors, microcontrollers, programmable logic devices, or other processing means. The processing operations performed by processor 710 include the execution of an operating platform or operating system on which applications and/or device functions are executed. The processing operations include operations related to I/O (input/output) with a human user or with other devices, operations related to power management, and/or operations related to connecting device 700 to another device. The processing operations may also include operations related to audio I/O and/or display I/O.

In one embodiment, device 700 includes audio subsystem 720, which represents hardware (e.g., audio hardware and audio circuits) and software (e.g., drivers, codecs) components associated with providing audio functions to the computing device. Audio functions may include speaker and/or headphone output, as well as microphone input. Devices for such functions may be integrated into device 700, or connected to device 700. In one embodiment, a user interacts with device 700 by providing audio commands that are received and processed by processor 710.

Display subsystem 730 represents hardware (e.g., display devices) and software (e.g., drivers) components that provide a visual and/or tactile display for a user to interact with the computing device. Display subsystem 730 may include display interface 732, which may include the particular screen or hardware device used to provide a display to a user. In one embodiment, display interface 732 includes logic separate from processor 710 to perform at least some processing related to the display. In one embodiment, display subsystem 730 includes a touchscreen device that provides both output and input to a user.

I/O controller 740 represents hardware devices and software components related to interaction with a user. I/O controller 740 may operate to manage hardware that is part of audio subsystem 720 and/or display subsystem 730. Additionally, I/O controller 740 illustrates a connection point for additional devices that connect to device 700 through which a user might interact with the system. For example, devices that may be attached to device 700 might include microphone devices, speaker or stereo systems, video systems or other display device, keyboard or keypad devices, or other I/O devices for use with specific applications such as card readers or other devices.

As mentioned above, I/O controller 740 may interact with audio subsystem 720 and/or display subsystem 730. For example, input through a microphone or other audio device may provide input or commands for one or more applications or functions of device 700. Additionally, audio output may be provided instead of or in addition to display output. In another example, if display subsystem includes a touchscreen, the display device also acts as an input device, which may be at least partially managed by I/O controller 740. There may also be additional buttons or switches on device 700 to provide I/O functions managed by I/O controller 740.

In one embodiment, I/O controller 740 manages devices such as accelerometers, cameras, light sensors or other environmental sensors, gyroscopes, global positioning system (GPS), or other hardware that may be included in device 700. The input may be part of direct user interaction, as well as providing environmental input to the system to influence its operations (such as filtering for noise, adjusting displays for brightness detection, applying a flash for a camera, or other features). In one embodiment, I/O controller 740 includes a touch controller to operate a touch sensor array that is included therein or coupled thereto. The touch controller may be coupled via a D-PHY to digital processor logic that is to perform digital processing of touch sensor information that is provided by the touch controller—e.g., with techniques and/or mechanisms discussed herein.

In one embodiment, device 700 includes power management 750 that manages battery power usage, charging of the battery, and features related to power saving operation. Memory subsystem 760 may include memory device(s) 762 for storing information in device 700. Memory subsystem 760 may include nonvolatile (state does not change if power to the memory device is interrupted) and/or volatile (state is indeterminate if power to the memory device is interrupted) memory devices. Memory 760 may store application data, user data, music, photos, documents, or other data, as well as system data (whether long-term or temporary) related to the execution of the applications and functions of system 700.

In one embodiment, memory subsystem 760 includes memory controller 764 (which could also be considered part of the control of system 700, and could potentially be considered part of processor 710). Memory controller 764 may communicate signaling to access memory 762—e.g., on behalf of processor 710.

Connectivity 770 may include hardware devices (e.g., wireless and/or wired connectors and communication hardware) and software components (e.g., drivers, protocol stacks) to enable device 700 to communicate with external devices. The device could be separate devices, such as other computing devices, wireless access points or base stations, as well as peripherals such as headsets, printers, or other devices.

Connectivity 770 may include multiple different types of connectivity. To generalize, device 700 is illustrated with cellular connectivity 772 and wireless connectivity 774. Cellular connectivity 772 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 774 refers to wireless connectivity that is not cellular, and may include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication occurs through a solid communication medium.

Peripheral connections 780 include hardware interfaces and connectors, as well as software components (e.g., drivers, protocol stacks) to make peripheral connections. It will be understood that device 700 could both be a peripheral device (“to” 782) to other computing devices, as well as have peripheral devices (“from” 784) connected to it. Device 700 commonly has a “docking” connector to connect to other computing devices for purposes such as managing (e.g., downloading and/or uploading, changing, synchronizing) content on device 700. Additionally, a docking connector may allow device 700 to connect to certain peripherals that allow device 700 to control content output, for example, to audiovisual or other systems.

In addition to a proprietary docking connector or other proprietary connection hardware, device 700 may make peripheral connections 780 via common or standards-based connectors. Common types may include a Universal Serial Bus (USB) connector (which may include any of a number of different hardware interfaces), DisplayPort including MiniDisplayPort (MDP), High Definition Multimedia Interface (HDMI), Firewire, or other type.

In one implementation, a device comprises a hardware interface to couple the device via an interconnect to a host, wherein the hardware interface is compatible with a control interface standard, one or more sensors to generate payload sensor data, a first buffer to store the payload sensor data, a second buffer to store sensor information other than any payload sensor data, and interface logic coupled to the first buffer and the second buffer, the interface logic comprising circuitry to participate in bidirectional serial communications via the hardware interface, including the interface logic to send the payload sensor data and the sensor information from the device via the hardware interface according to a priority of the second buffer over the first buffer.

In an embodiment, the hardware interface is compatible with an I²C specification or an I3C specification. In another embodiment, the control interface standard is a camera command interface standard of a camera serial interface (CSI) specification. In another embodiment, the sensor information includes a token to indicate a risk of payload sensor data being overwritten in the first buffer. In another embodiment, the sensor information includes a token to indicate a risk of the first buffer being starved of payload sensor data. In another embodiment, the device further comprises a cryptographic unit to encrypt the payload sensor data. In another embodiment, the interface logic to send the payload sensor data and the sensor information according to the priority of the second buffer over the first buffer includes the interface logic to send the sensor information in an in-band interrupt. In another embodiment, the first buffer and the second buffer include circular buffers.

In another implementation, a method comprises generating payload sensor data with one or more sensors of a device, wherein a hardware interface couples the device via an interconnect to a host, wherein the hardware interface is compatible with a control interface standard, storing the payload sensor data to a first buffer of the device, storing, to a second buffer of the device, sensor information other than any payload sensor data, and exchanging bidirectional serial communications with the host device, including sending the payload sensor data and the sensor information from the device via the hardware interface according to a priority of the second buffer over the first buffer.

In an embodiment, the hardware interface is compatible with an I²C specification or an I3C specification. In another embodiment, the control interface standard is a camera command interface standard of a camera serial interface (CSI) specification. In another embodiment, the sensor information includes a token indicating a risk of payload sensor data being overwritten in the first buffer. In another embodiment, the sensor information includes a token indicating a risk of the first buffer being starved of payload sensor data. In another embodiment, the method further comprises encrypting the payload sensor data by the device. In another embodiment, sending the payload sensor data and the sensor information according to the priority of the second buffer over the first buffer includes sending the sensor information in an in-band interrupt. In another embodiment, the first buffer and the second buffer include circular buffers.

In another implementation, a non-transitory computer-readable storage medium has stored thereon instructions which, when executed by one or more processing units, cause the one or more processing units to perform a method comprising storing to a first buffer of a device payload sensor data generated with one or more sensors of the device, wherein a hardware interface couples the device via an interconnect to a host, wherein the hardware interface is compatible with a control interface standard, storing, to a second buffer of the device, sensor information other than any payload sensor data, and exchanging bidirectional serial communications with the host device, including sending the payload sensor data and the sensor information from the device via the hardware interface according to a priority of the second buffer over the first buffer.

In an embodiment, the hardware interface is compatible with an I²C specification or an I3C specification. In another embodiment, the control interface standard is a camera command interface standard of a camera serial interface (CSI) specification. In another embodiment, the sensor information includes a token indicating a risk of payload sensor data being overwritten in the first buffer. In another embodiment, the sensor information includes a token indicating a risk of the first buffer being starved of payload sensor data. In another embodiment, the method further comprises encrypting the payload sensor data by the device. In another embodiment, sending the payload sensor data and the sensor information according to the priority of the second buffer over the first buffer includes sending the sensor information in an in-band interrupt. In another embodiment, the first buffer and the second buffer include circular buffers.

In another implementation, a system comprises a host device including a processor, an interconnect, and a first device including a hardware interface that is compatible with a control interface standard, wherein the first device is coupled to the host device via the hardware interface and the interconnect, one or more sensors to generate payload sensor data, a first buffer to store the payload sensor data, a second buffer to store sensor information other than any payload sensor data, and interface logic coupled to the first buffer and the second buffer, the interface logic comprising circuitry to participate in bidirectional serial communications via the hardware interface, including the interface logic to send the payload sensor data and the sensor information from the first device via the hardware interface according to a priority of the second buffer over the first buffer.

In an embodiment, the hardware interface is compatible with an I²C specification or an I3C specification. In another embodiment, the control interface standard is a camera command interface standard of a camera serial interface (CSI) specification. In another embodiment, the sensor information includes a token to indicate a risk of payload sensor data being overwritten in the first buffer. In another embodiment, the sensor information includes a token to indicate a risk of the first buffer being starved of payload sensor data. In another embodiment, the first device further comprises a cryptographic unit to encrypt the payload sensor data. In another embodiment, the interface logic to send the payload sensor data and the sensor information according to the priority of the second buffer over the first buffer includes the interface logic to send the sensor information in an in-band interrupt. In another embodiment, the first buffer and the second buffer include circular buffers.

In another implementation, a device comprises means for generating payload sensor data with one or more sensors of a device, wherein a hardware interface couples the device via an interconnect to a host, wherein the hardware interface is compatible with a control interface standard, means for storing the payload sensor data to a first buffer, and means for storing, to a second buffer, sensor information other than any payload sensor data. The device further comprises means for exchanging bidirectional serial communications with the host device, including means for sending the payload sensor data and the sensor information from the device via the hardware interface according to a priority of the second buffer over the first buffer.

In an embodiment, the hardware interface is compatible with an I²C specification or an I3C specification. In another embodiment, the control interface standard is a camera command interface standard of a camera serial interface (CSI) specification. In another embodiment, the sensor information includes a token indicating a risk of payload sensor data being overwritten in the first buffer. In another embodiment, the sensor information includes a token indicating a risk of the first buffer being starved of payload sensor data. In another embodiment, the device further comprises means for encrypting the payload sensor data by the device. In another embodiment, the means for sending the payload sensor data and the sensor information according to the priority of the second buffer over the first buffer includes means for sending the sensor information in an in-band interrupt. In another embodiment, the first buffer and the second buffer include circular buffers.

Techniques and architectures for communicating sensor information are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device comprising:
a hardware interface to couple the device via an interconnect to a host, wherein the hardware interface is compatible with a control interface standard;
one or more sensors to generate payload sensor data;
a first buffer to store the payload sensor data;
a second buffer to store sensor information other than any payload sensor data; and
interface logic coupled to the first buffer and the second buffer, the interface logic comprising circuitry to participate in bidirectional serial communications via the hardware interface, including the interface logic to send the payload sensor data and the sensor information from the device via the hardware interface according to a priority of the second buffer over the first buffer.

2. The device of claim 1, wherein the hardware interface is compatible with an I²C specification or an I3C specification.

3. The device of claim 2, wherein the control interface standard is a camera command interface standard of a camera serial interface (CSI) specification.

4. The device of claim 1, wherein the sensor information includes a token to indicate a risk of payload sensor data being overwritten in the first buffer.

5. The device of claim 1, wherein the sensor information includes a token to indicate a risk of the first buffer being starved of payload sensor data.

6. The device of claim 1, further comprising a cryptographic unit to encrypt the payload sensor data.

7. The device of claim 1, wherein the interface logic to send the payload sensor data and the sensor information according to the priority of the second buffer over the first buffer includes the interface logic to send the sensor information in an in-band interrupt.

8. The device of claim 1, wherein the first buffer and the second buffer include circular buffers.

9. A method comprising:
generating payload sensor data with one or more sensors of a device, wherein a hardware interface couples the device via an interconnect to a host, wherein the hardware interface is compatible with a control interface standard;
storing the payload sensor data to a first buffer of the device;
storing, to a second buffer of the device, sensor information other than any payload sensor data; and
exchanging bidirectional serial communications with the host device, including sending the payload sensor data and the sensor information from the device via the hardware interface according to a priority of the second buffer over the first buffer.

10. The method of claim 9, wherein the hardware interface is compatible with an I²C specification or an I3C specification.

11. The method of claim 10, wherein the control interface standard is a camera command interface standard of a camera serial interface (CSI) specification.

12. The method of claim 9, wherein the sensor information includes a token indicating a risk of payload sensor data being overwritten in the first buffer.

13. The method of claim 9, wherein the sensor information includes a token indicating a risk of the first buffer being starved of payload sensor data.

14. A non-transitory computer-readable storage medium having stored thereon instructions which, when executed by one or more processing units, cause the one or more processing units to perform a method comprising:
storing to a first buffer of a device payload sensor data generated with one or more sensors of the device, wherein a hardware interface couples the device via an interconnect to a host, wherein the hardware interface is compatible with a control interface standard;
storing, to a second buffer of the device, sensor information other than any payload sensor data; and
exchanging bidirectional serial communications with the host device, including sending the payload sensor data and the sensor information from the device via the hardware interface according to a priority of the second buffer over the first buffer.

15. The computer-readable storage medium of claim 14, wherein the hardware interface is compatible with an I²C specification or an I3C specification.

16. The computer-readable storage medium of claim 15, wherein the control interface standard is a camera command interface standard of a camera serial interface (CSI) specification.

17. The computer-readable storage medium of claim 14, further comprising encrypting the payload sensor data by the device.

18. A system comprising:
a host device including a processor;
an interconnect; and
a first device including:
a hardware interface that is compatible with a control interface standard, wherein the first device is coupled to the host device via the hardware interface and the interconnect;
one or more sensors to generate payload sensor data;
a first buffer to store the payload sensor data;
a second buffer to store sensor information other than any payload sensor data; and
interface logic coupled to the first buffer and the second buffer, the interface logic comprising circuitry to participate in bidirectional serial communications via the hardware interface, including the interface logic to send the payload sensor data and the sensor information from the first device via the hardware interface according to a priority of the second buffer over the first buffer.

19. The system of claim 18, wherein the hardware interface is compatible with an I²C specification or an I3C specification.

20. The system of claim 19, wherein the control interface standard is a camera command interface standard of a camera serial interface (CSI) specification.

21. A device comprising:
means for generating payload sensor data with one or more sensors of a device, wherein a hardware interface couples the device via an interconnect to a host, wherein the hardware interface is compatible with a control interface standard;
means for storing the payload sensor data to a first buffer;
means for storing, to a second buffer, sensor information other than any payload sensor data; and
means for exchanging bidirectional serial communications with the host device, including means for sending the payload sensor data and the sensor information from the device via the hardware interface according to a priority of the second buffer over the first buffer.

22. The device of claim 21, wherein the hardware interface is compatible with an I2C specification or an I3C specification.

23. The device of claim 22, wherein the control interface standard is a camera command interface standard of a camera serial interface (CSI) specification.

24. The device of claim 21, further comprising means for encrypting the payload sensor data by the device.
